(19) United States
(12) Patent Application Publication
(10) Pub. No.: US 2021/0129420 A1
(43) Pub. Date: May 6, 2021

(54) METHOD FOR PRODUCING A THREE-DIMENSIONAL, MULTI-LAYER FIBRE COMPOSITE COMPONENT

(71) Applicant: Fraunhofer-Gesellschaft zur Forerung der angwandten Forschung e.V., Munchen (DE)

(72) Inventors: Christian Dörsch, Bremerhaven (DE); Heiko Rosemann, Bremerhaven (DE)

(21) Appl. No.: 16/321,690

(22) PCT Filed: Jul. 31, 2017
(86) PCT No.: PCT/EP2017/069298

§ 371 Date: Jan. 29, 2019

(30) Foreign Application Priority Data
Aug. 1, 2016 (DE) 102016214187.2

(51) Int. Cl. B29C 64/106; B29C 64/336; B32B 5/24

(52) U.S. Cl. CPC B29C 64/106; B33Y 10/00; B32B 5/24; B29C 64/336

(57) ABSTRACT

The invention relates to a method for producing a three-dimensional, multi-layer fibre composite component. In the method, a curable matrix material is applied to an object carrier in layers, in matrix layers arranged on top of one another. The object carrier can be a plate, for example, which is not part of the component and on which a fibre composite component is constructed layer by layer. In a further embodiment, the object carrier can be a component core, which is part of the fibre composite component and on which the matrix layers can be applied.

The invention relates to a method for manufacturing a three-dimensional, multi-layered fibre composite component according to the preamble of claim 1.

According to the state of the art, it is known to manufacture products by way of additive manufacture. It is particularly with the construction of prototypes that plastic parts are required in small numbers, wherein these are manufactured using manufacturing methods such as rapid prototyping.

A method in which a continuous fibre is fed simultaneously to the generative deposition of a thermoplastic material and embedded into the thermoplastic is known from EP 2 739 460, which forms the basis of the preamble of claim 1.

WO 2014/193505 A1 shows a machine for manufacturing a fibre-reinforced component by way of additive manufacture. The machine can comprise a working surface, a matrix feed for depositing matrix layers onto the working surface and a fibre feed configured for depositing a fibre layer onto at least one of the matrix layers. The deposition of the matrix layers and the fibre layers can be controlled by a computer.

During additive manufacturing, individual layers of matrix material are deposited onto an object carrier and a curing process, for example by way of heating, often takes place after the deposition of each layer in order to solidify the layer. A further layer can then be deposited onto this layer, said further layer again being cured, so that a component is constructed layer by layer by repeating these steps.

The manufacture of fibre composite components is either carried out with at least one single-sided mould half or with a core, onto which mould half or core the material is deposited in a layered manner, manually or by machine. A manufacture of fibre-reinforced fibre composite components with approximately significant mechanical characteristics, for example static and/or dynamic strengths or elasticities, is therefore not available. For these reasons, in the manufacture of industrial application products, additive manufacturing is only used for metal products or in areas in which the demands placed upon the material characteristics regarding strength and stability are not high.

It is the object of the invention to provide a method for manufacturing a strong and elastic and therefore mechanically resistant fibre composite component which fulfils the industrial demands on the material characteristics concerning strength, stability and complexity as well as taking into account the industrial demands concerning economic efficiency and a reduced manufacturing time.

The object is achieved by a method with the features of claim 1. Advantageous further developments are to be derived from the features of the dependent claims and of the embodiment examples.

The suggested method is suitable for manufacturing a three-dimensional, multi-layered fibre composite component. Using this method, a curable matrix material is deposited in layers onto an object carrier in matrix layers which are arranged above one another. The object carrier can for example be a plate, which is not part of the component and on which a fibre composite component is built up layer by layer. In a further embodiment, the object carrier can be a component core which is part of the fibre composite component and onto which the matrix layers can be deposited. A matrix layer is therefore characterised in that this is deposited in a layered manner following a contour of the object carrier. A curing procedure, for example by way of heating, which cures the matrix layer, can be carried out after each layer deposition so that the matrix material remains in its deposited layer shape. A further layer can therefore be deposited onto the cured layer. Preferably, a layer is first completely deposited and cured before beginning with a new layer. The matrix material is deposited by way of at least one depositing unit which is movable relative to the object carrier. Herein, the depositing unit can have a multi-axis geometry with at least 3, preferably 6 axes.

In a further step, at least one fibre element is deposited strand by strand at least regionally onto at least one of the matrix layers by way of at least one laying head which is movable relative to the object carrier. A fibre element for example can be a so-called continuous fibre, i.e. a fibre strand which is wound for example on a bobbin and has a length of several metres. This “continuous fibre” can be deposited onto a matrix layer in a selectable length by the laying head and be cut in a selectable length. If the continuous fibre has been depleted, then a further continuous fibre can be wound onto the bobbin, so that the length of the wound-on fibre elements appears “endless”. The laying head can have a multi-axis geometry which comprises at least 3, preferably 6 axes. The multi-axis geometry can preferably be the same multi-axis geometry on which the depositing unit is likewise arranged.

The matrix material is a thermosetting polymer. Thermosetting polymers are hard and brittle materials which have a high strength and temperature resistance. Additionally, short fibres are embedded into the thermosetting matrix material in order to increase the elasticity and the strength of the fibre composite component.

The short fibres can preferably be glass fibres or carbon fibres with higher modulus of elasticity than the modulus of elasticity of the matrix material. The aim of the embedding of the short fibres into the thermosetting matrix material is to use the respective positive mechanical characteristics of the matrix material and of the short fibres, so that the composite of the matrix material and short fibres has a greater elasticity and strength than that of the matrix material and a greater strength than that of the short fibres. The short fibres preferably have a smaller length than the deposited fibre element. This allows for an improved mixing of the short fibres with the matrix material. The modulus of elasticity of the matrix material with embedded short fibres is dependent on the matrix material and short fibre material as well as the amount of short fibres and typically lies between 2 and 14 GPa. Parts of highly stressed components can, however, be subjected to greater loads. The fibre element is additionally deposited in regions in order to solve such a problem. The fibre element can preferably be deposited onto the component such that it is subjected to a tensile load along its longitudinal axis. The tensile modulus of elasticity of the fibre element along its longitudinal axis is preferably at least 70 GPa. This is significantly greater compared with the tensile modulus of elasticity of typical thermoplastics (1 to 3 GPA) and thermosetting polymers (ca. 1 GPa) and can therefore favour the elasticity of the fibre composite component.

The combination of thermosetting matrix material with embedded short fibres and additionally with at least one regionally deposited fibre element can permit the use of fibre composite components as medium-strength to high-strength functional components on account of the improved structure characteristics of the overall construction.

The selected material combination therefore solves the problem of fibre composite components, which are subjected to a medium to high mechanical load and feature a strength of at least 10 GPa and modulus of elasticity of between 12 and 15 GPa, being difficult or indeed impossible to manufacture by way of additive manufacturing methods according to the state of the art. The reason for this is that commonly used plastics either have a high strength and a low elasticity or a high elasticity and a low strength. This results in additive manufacturing methods according to the present state of the art using thermoplastic matrix materials which have a high elasticity given a low strength, but are simpler to process in comparison to brittle plastics, and it appears to be simpler to increase the strength by way of an additional deposition of fibre elements than to achieve an increased elasticity given brittle components. In contrast to thermosetting polymers which are heated once above the cross-linking temperature (but below the decomposition temperature), thermoplastics change their shape and become liquid when heated, as is the case with brittle plastics. With thermoplastics, this procedure is essentially reversible. This is the case for a longer exposure to a lower temperature as well as for brief, intense heating.

Complex component shapes, in particular hollow components, can be constructed layer by layer by way of additive methods without component cores which are expensively manufactured with moulds in conventional methods. Less cut waste also arises with the method according to the invention, even in comparison to the use of laid fabrics, so that material can be saved. The targeted, material-saving component reinforcement further has an advantageous effect on the weight reduction of the fibre composite component.

In one possible embodiment, the matrix material can be thixotropic. In this case, the method may include an additional step. The viscosity of the matrix material can be reduced before deposition, for example by way of stirring, i.e. the matrix material becomes thinner. This makes the deposition easier. If the matrix material is no longer loaded in shear after the deposition, then it solidifies again up to its initial viscosity, i.e. the state which it had before the action of shear forces, for example due to stirring. The matrix material can therefore contribute additionally or alternatively to the later curing for shaping the fibre composite component, even before the method step of the curing. The difference between the starting viscosity and the minimal viscosity can lie between 50 mPA s and 10 000 mPA s.

In some possible embodiments, the matrix material can be duromeric foam. In a further embodiment, the matrix material can, depending on the construction of the desired structure of the fibre composite part, be a fibre-containing matrix or a duromeric foam, alternating in layers. An advantage of this design is the possibility of manufacturing components and/or component cores with a low density and high strength. Particularly preferably, polyurethane foams can serve as a matrix material. However, other thermosetting polymers capable of foaming such as for example epoxy can also be used as a matrix material. The density can be for example at least 50 kg/m³, preferably at least 75 kg/m³, in particular preferably at least 80 kg/m³. Furthermore, the density can be for example at the most 800 kg/m³, preferably at the most 700 kg/m³, particularly preferably at the most 600 kg/m³. A compressive strength can be for example at least 50 N/mm², preferably at least 70 N/mm², particularly preferably at least 80 N/mm². The compressive strength can be for example at the most 600 N/mm², preferably at the most 700 N/mm² or particularly preferably at the most 800 N/mm². The compressive strength can be determined by way of at least one test described in one of the following standards: ISO 844, DIN EN ISO 3386, DIN EN ISO 604, DIN EN 2850, DIN V 65380, DIN 65375 or a comparable standard.

In a further preferred embodiment, the matrix layers can have a thickness of at least 0.05 mm, preferably at least 1 mm and/or at the most 300 mm, preferably at the most 100 mm, particularly preferably at the most 40 mm.

In a further possible embodiment, the object carrier can be part of the fibre composite component. In this embodiment, for example premanufactured components and/or component cores can serve as object carriers. A direct connection of the matrix material to the premanufactured component can be achieved by way of the deposition of matrix material onto the premanufactured component, so that connection elements such as welding seams for example can be done away with.

The depositing unit in a further embodiment can comprise an extruding head, so that the matrix material can be deposited by way of extrusion. On extruding, complex shapes can be deposited by way of strands. It is also advantageous that brittle matrix materials which are firm or highly viscous can be extruded, since these can be pressed under pressure through a nozzle or a so-called mouthpiece. The matrix material can alternatively also be deposited by droplets. With deposition by way of droplets, it is advantageous that no high pressures are necessary. However, it is very difficult for firm or highly viscous matrix materials to be deposited in droplets.

In a further possible embodiment, the depositing unit and/or the laying head can be movable independently of one another. This has the advantage that the fibre element can be deposited onto the fibre composite component to be manufactured, independently of a traversing path of the depositing unit. The depositing unit and/or the laying head can preferably be attached to a multi-axis geometry, wherein the multi-axis geometry preferably has 3, particularly preferably 6 axes.

In a further embodiment, the fibre element can be pre-impregnated with a liquid, for example with an epoxy resin adhesive, before the deposition onto the matrix material. The fluid can preferably be an adhesive, so that the fibre element can be bonded onto the matrix material. Additionally or alternatively, the fibre element can be embedded into the matrix material before the latter is completely cured, so that the fibre element is partly or completely enclosed by the matrix material. The component can therefore also be reinforced in regions in which loadings of the component occur in the interior of the component. The deposited fibre element can preferably have a length of at least 0.5 mm, preferably at least 1 mm, in particular preferably at least 10 mm and comprise at least one glass fibre or carbon fibre. Glass fibres and carbon fibres typically have a high tensile elasticity greater than 70 GPA, so that they can withstand high tensile loads.

In a particularly preferred form, the short fibres which are embedded into the matrix material can have a maximum length of 100 mm. The length of the embedded short fibres can be varied during the depositing.

In a further embodiment, the short fibres can be admixed to the matrix material in the depositing unit. What is particularly advantageous for example is an extruding mixing head, in which the method steps of embedding short fibres and depositing matrix material can be carried out simultaneously. For example, an essentially homogeneous fibre distribution can be achieved by way of this. A homogeneous fibre distribution is advantageous in achieving an essentially homogeneous stability and component quality.

Short fibres can be embedded into one or more layers of matrix material. The component elasticity as well as the tensile strength is increased in regions in which short fibres are embedded into the matrix material, as explained above. With this embodiment, it is advantageous that short fibres can be embedded into regions in which a loading of the component occurs. The weight and material amount of a component to be manufactured can thus be tailored to later loads. Hence no short fibres need to be embedded into layers in which a reinforcement is not necessary.

Short fibres can be deposited between two layers of matrix material for the targeted application of short fibres in the component. The short fibres can also be deposited between the fibre element and the matrix material. In a further embodiment, the short fibres can be pre-impregnated with a liquid, for example with an adhesive.

In a further advantageous embodiment, the short fibres can be embedded into the matrix material in a directed manner, i.e. a longitudinal axis of the short fibres has a direction which is set before the deposition, and preferably this direction corresponds to the direction of the tensile loads of the fibre composite component. The short fibres can be embedded into the matrix material with their longitudinal axis along the traversing path of the depositing unit of the matrix material by way of a short fibre laying head or another depositing unit. The short fibres have the highest tensile modulus of elasticity along their longitudinal axis. This embodiment has the advantage that the short fibres can be aligned in the direction of tensile loading and the component can thus withstand greater tensile loads than given an unordered embedding of the short fibres.

A volume of the short fibres which are contained in the matrix material can be at least 10% by volume, preferably at least 30% by volume, in particular preferably at least 35% by volume and/or at the most 80% by volume, preferably at the most 70% by volume, in particular preferably at the most 60% by volume compared to a total matrix volume, for an essentially homogeneous fibre distribution, wherein the total matrix volume is a sum of the volume of the embedded short fibres and a volume of the matrix material. A higher share of short fibres in the matrix material has the advantage that the matrix material short fibre mixture can have a higher elasticity and can therefore withstand greater tensile loads. One can also envisage the volume share of the short fibres vis-à-vis the total matrix volume being varied in layers during the deposition of matrix material, so that the fibre composite component preferably comprises regions with different short fibre volume shares. This embodiment has the advantage that the fibre composite component which is to be manufactured can be adapted precisely to later loads with regard to its weight and material expense.

The method step II can be carried out before the method step III and/or the method step III before the method step II. The fibre element can be embedded into the matrix material or be deposited onto matrix layers in a targeted manner after the curing, depending on the demands placed upon the fibre composite component. This has the advantage that the fibre element can also be embedded into inner-lying layers of the fibre composite component. The fibre element can therefore also accommodate tensile loads which occur in the inside of the fibre composite component.

The subject-matter of the application is also a fibre composite component which has the construction outlined in this application and has preferably been manufactured with the method according to the application. Further developments are to be derived from the description of the embodiment example.

Advantageous embodiments of the invention are hereafter explained by way of the figures.

There are shown in:

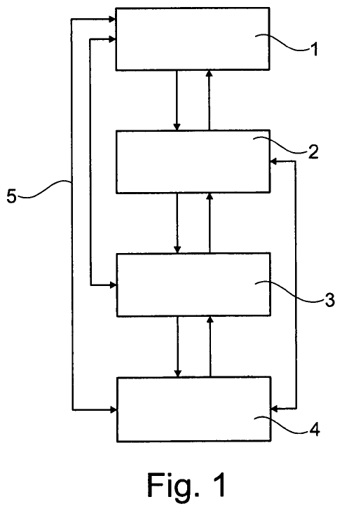

FIG. 1 a flow diagram with method steps of a method for manufacturing a three-dimensional, multi-layered fibre composite component,

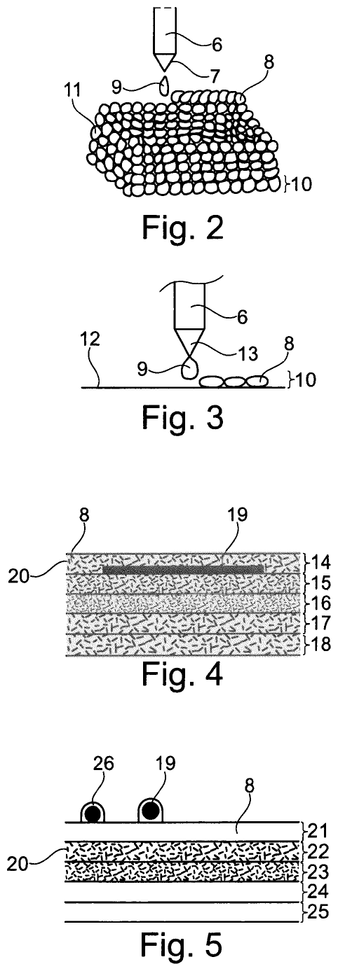

FIG. 2 a perspective representation of a depositing unit during a depositing of matrix material,

FIG. 3 a schematic representation of a depositing unit during a depositing of matrix material,

FIG. 4 a layered construction of the fibre composite component in a detail of a component cross-section,

FIG. 5 a layered construction of the fibre composite component with impregnated fibre elements in a detail of a component cross-section,

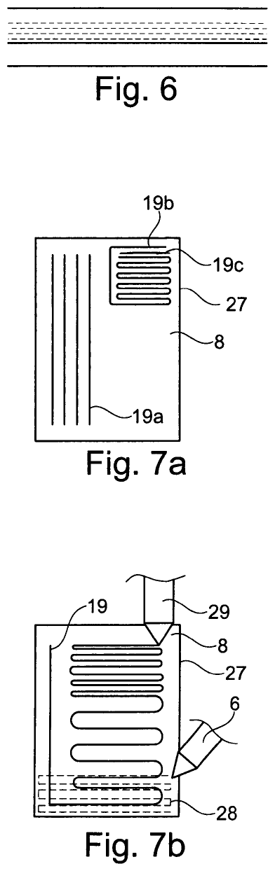

FIG. 6 a layered construction of the fibre composite component with aligned short fibres between two matrix layers,

FIGS. 7a and 7b different plan views upon a fibre composite component with a fibre element,

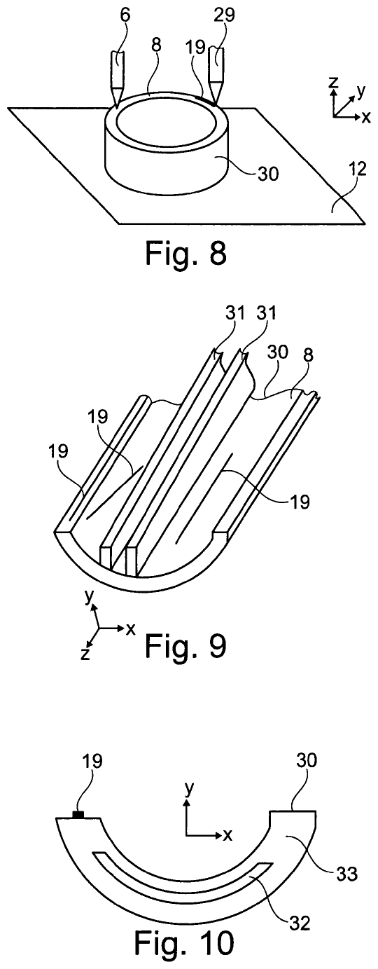

FIG. 8 a schematic representation of a manufacture of a rotor blade,

FIG. 9 a longitudinal section of the rotor blade and

FIG. 10 a cross-section of the rotor blade.

A flow diagram with four steps of a method for manufacturing a three-dimensional multi-layered fibre composite component is represented in FIG. 1. The method steps are:
1 depositing matrix material,
2 embedding short fibres,
3 depositing a fibre element and
4 curing.

Arrows, of which one is provided with the reference numeral 5 by way of example, show different embodiment sequences. The method may begin with the method step 1, 2 or 3. In an exemplary embodiment, matrix material is first mixed with short fibres in a depositing unit, for example in an extruding mixing head. In the embodiment, the matrix material is a thermosetting polyurethane, but the matrix material can also be a different thermosetting matrix material, for example epoxy resin or formaldehyde resin. In the shown example, the short fibres are of glass fibres. The short fibres can also be of other materials, for example of carbon fibres or natural fibres such as for example wood fibres. In the shown example, the matrix material is thixotropic. The short fibres and the matrix material are each stored in a material store. The matrix material is stirred in the material store, so that the viscosity of the matrix material is reduced on account of its thixotropy. The short fibres are admixed to the matrix material in the extruding mixing head before a deposition, before flowing out of a depositing nozzle. The matrix short fibre mixture in a first step is deposited through the extruding head, for example through the depositing nozzle, onto an object carrier, i.e. the extruding mixing head travels along a contour of the object carrier and extrudes a matrix short fibre mixture strand onto the object carrier. On depositing, the matrix short fibre mixture preferably has at least a length which corresponds to double the width. The matrix fibre mixture is cured, for example by way of heating, after the depositing of a complete layer. After the curing, a further strand of the matrix fibre mixture is deposited onto the first strand. A fibre element is subsequently applied onto the second matrix layer by way of a laying head, so that the fibre element, for example a glass fibre tape, is enclosed at least partly by the matrix fibre mixture which has not yet fully cured. A curing procedure of the matrix material, for example by way of heating, follows this. The method steps can be combined and repeated in any order. The matrix fibre mixture can be deposited by way of a strand, but also in droplets. The object carrier can be for example a plate which during the manufacturing process supports the fibre composite component which is to be manufactured, but is not part of the component. The object carrier can also be part of the fibre composite component, for example in the form of a premanufactured component core, for example of an additively premanufactured component core of duromeric foam.

FIG. 2 illustrates the method step 1 of depositing matrix material 8. The depositing unit 6 comprises an opening 7, through which the matrix material 8 is issued in droplets. After leaving the opening 7, the matrix material is still in a viscous state. Droplets 9 are deposited next to one another, so that these connect and matrix layers 10 are formed. After the deposition of a matrix layer 10, the matrix material 8 cures, for example by way of heating. The matrix layers 10 form a part of a component 11. The component 11 is hollow on the inside. The matrix material 8 is alternatively deposited by strand. The matrix material 8 can for example be a thixotropic material, for example thermosetting polyurethane.

FIG. 3 shows a depositing unit on depositing a layer. Recurring features in this and in the following figures are provided with the same reference numerals. A part of a depositing unit 6 has an opening 7, through which the matrix material 8 is issued in droplets. The matrix material 8 is deposited onto an object carrier 12. In the shown example, the object carrier 12 is not part of the component 11. In other embodiments, the object carrier 12 can be part of the component 11. Droplets 9 are deposited next to one another at a distance of for example 1 mm and subsequently connect with the adjacently arranged droplets on the object carrier to form a matrix layer 10 on account of their fluid state. Additionally or alternatively, the matrix material 8 can be deposited onto the object carrier 12 in strands. In the shown example, the depositing unit 6 is designed as a nozzle 13. The depositing unit 6 in further embodiments can be designed as an extruding head and/or as an extruding mixing head. Short fibres are admixed to the matrix material in the extruding mixing head before the deposition.

A detail of a component cross-section is represented in FIG. 4. The component cross-section shows five matrix layers 14-18. In an initially deposited layer 14, a fibre element 19 is embedded into the matrix material 8. In the example, the fibre element 19 is completely enclosed by matrix material 8. In other embodiments, the fibre element 18 is only partly enclosed by matrix material 8. The fibre element 18 is 6 cm long in the shown example. Short fibres—one of these is provided with the reference numeral 20 by way of example—are embedded into the matrix material 8 in the five layers 14 to 18. The short fibres 20 are embedded into the matrix layers 14 to 18 in an unordered manner, i.e. in a random direction distribution. In another embodiment example, the short fibres 20 can also be embedded into the matrix material 8 in a directed and/or ordered manner, for example by way of these lying with their longitudinal axis along the travel path of the depositing unit. The short fibres contained in the matrix material have a share of for example 30% by volume of a total matrix volume, wherein the total matrix volume is the sum of the matrix material volume and the short fibre volume. This material mixture, for example thermosetting polyester resin with short glass fibres, effects for example a high elasticity, for example a tensile modulus of elasticity of 14 GPA, given a simultaneously high bending strength, for example 120 MPA, of a fibre composite component to be manufactured.

A detail of a component cross-section is represented in FIG. 5. The component cross-section shows five matrix layers 21 to 25. Two fibre elements 19 are deposited on the first layer 21. The fibre elements 19 are enclosed by a liquid, in this embodiment example by an adhesive 26, for example an epoxy resin. In other embodiment examples, the liquid can also be a different liquid. In the second 22 and the third layer 23, short fibres 20 are embedded into the matrix material 8. No short fibres 20 or fibre elements 19 are embedded in the first layer 21 and the fourth 24 and fifth layer 25.

A detail of a fibre composite component which illustrates a three-layered deposition of matrix material 8 and short fibres 20 is represented in FIG. 6. Directed short fibres 20 form a middle layer. The matrix material 8 can be for example a duromeric polyurethane. The short fibres can be for example glass fibres, in particular e-glass fibres. A depositing unit 6, for example an extruding laying head, deposits a layer of matrix material 8 onto an object carrier 12, the matrix material is cured in a next method step, for example by way of heating. In the shown example, the depositing unit 6 subsequently applies a multitude of short fibres 20, for example glass fibres, in particular e-glass fibres, onto the first layer of matrix material 8. The short fibres are applied onto the first matrix layer in a directed manner, parallel along their longitudinal axes and along their longitudinal axis pointing in the direction of a tensile loading direction of the fibre composite component. The tensile modulus of elasticity of the e-glass fibres is for example 70 GPa. In a further method step, a second layer of matrix material 8 is deposited onto the short fibres 20 by way of the depositing unit 6 and cured. In the shown example, the matrix material 8 of the second matrix layer encloses the deposited short fibres 20. In the shown example, the second layer of matrix material 8 is subsequently cured and therefore fixes the short fibres in their directed position on curing.

In another embodiment, short fibres 20 can be deposited onto the deposited matrix layer also without the method step of curing, so that these fibres are already embedded into the firstly deposited matrix layer. In another embodiment, the matrix material can be firmer, so that the second deposited layer of matrix material 8 remains on the short fibres and does not completely enclose the short fibres.

A plan view of a fibre composite component 27 is represented in FIG. 7a. Fibre elements 19a, 19b and 19c are deposited onto the fibre composite component 27. The fibre elements 19a and 19c are deposited in a straight line. The fibre element 19b is deposited in a meandering manner. Four fibre elements are deposited in parallel in straight stands. The fibre elements, for example glass fibres, carbon fibres or natural fibres, have a tensile modulus of elasticity between 70 and 400 GPA. This effects a high elasticity of the fibre composite component 27 in the regions, in which fibre elements are deposited in the direction of tensile loading. As shown in the example, tensile loads in different directions of the fibre composite component 27 can be accommodated by a free deposition shape, i.e. by an arbitrarily selectable shape of the deposition geometry. The fibre elements 19a, 19b, and 19c are deposited in different regions of the fibre composite part.

A further plan view of a fibre composite component 27 with a fibre element 19 is represented in FIG. 7b. In the present embodiment example, the fibre element 19 is deposited onto the matrix material 8 in a curved manner. The fibre element 19 does not overlap. In other embodiment examples, the fibre element 19 can also be arranged in such a way that it overlaps itself. The fibre element 19 comprises for example carbon fibres and/or glass fibres, but can also comprise other materials such as natural fibres, e.g. sisal, kenaf, hemp or similar long fibres. The fibre element 19 has a length for example of 16 cm. Furthermore, a depositing unit 6 and its traversing path 28 are represented. The fibre element 19 is deposited by a laying head 29. A traversing path of the laying head 29 corresponds to the shape of the deposited fibre element 19 and does not necessarily correspond to the traversing path 28 of the depositing unit 6 of the matrix material 8. The laying head 29 and the depositing unit 6 can be simultaneously active. The laying head 29 and the depositing unit 6 can be arranged in parallel. The laying head 29 and the depositing unit 6 can be arranged for example on a multi-axis geometry. The multi-axis geometry preferably comprises 3 axes, in particular preferably 6 axes. The laying head 29 and the depositing unit 6 can move on the multi-axis geometry independently of one another.

FIG. 8 in a schematic representation shows a manufacture of a rotor blade 30 of a wind turbine. The rotor blade is a hollow component which is essentially annulus-shaped in the region of the rotor hub i. A depositing unit 6 deposits matrix material 8 onto an object carrier 12 in a layered manner. In this embodiment, the depositing unit 6 travels a circular path, wherein the travelled circles are concentric with the annulus of the rotor blade and deposits matrix material 8 in a layered manner. The path however can also assume the geometry of a rotor blade cross-section, i.e. can become elliptical or streamline with an increasing layer number. In the shown example, a laying head 29 regionally deposits a fibre element 19 onto the already deposited matrix layers of the annulus. The fibre element 19 is deposited with a curvature which corresponds to a curvature of the annulus of the rotor blade. In the shown example, the matrix material 8 is cured after the deposition of a layer by the depositing unit and after the fibre element 19 has been embedded. The fibre element is enclosed by matrix material 8, but in a further embodiment can however also only be partly enclosed by matrix material 8. No additional adhesive is necessary for fixing the fibre element 19 after embedding the fibre element 19 due to the curing of the matrix material 8, since the matrix material 8 fixes the fibre element 10 in the matrix layer on curing. In this embodiment example, the object carrier 12 is not part of the fibre composite component. The matrix material 8 can be mixed with short fibres which, for example before the depositing of the matrix material, have been embedded into the matrix material. The short fibres can be for example UMS carbon fibres, which have a tensile modulus of elasticity of 395 GPa. This has the advantage that an elasticity of the rotor blade 30 is increased in regions of the short fibres 20 which are admixed to the matrix material 8.

A longitudinal section of a rotor blade 30 of a wind turbine is represented in FIG. 9. The longitudinal section lies in the xz plane. The detail of the rotor blade in the longitudinal section has the shape of an extended semi-annulus which with the inside of the circle points upwards (in the y-direction). Two trapezoidal stabilisation webs 31, for example of thermosetting polyurethane are attached on the rotor blade 30. The stabilisation webs 31 with regard to their longitudinal axis lie parallel to one another and with their longitudinal axis are arranged parallel to the longitudinal axis of the rotor blade 30. The stabilisation webs reinforce the rotor blade 30 and increase a bending stiffness and torsion stiffness. In the shown example, fibre elements 19, for example of e-glass fibres, are deposited onto the rotor blade 10 in different regions, in order to increase a tensile strength. In the shown example, two fibre elements 19 are deposited on the inner lateral surface of the rotor blade each on a side of the stabilisation webs 31. A further fibre element 19 is embedded into the matrix material 8, for example on the section edge along the longitudinal axis of the rotor blade opposite to the z-direction.

A cross-section of the rotor blade 30 of the wind turbine is represented in FIG. 10. The cross-section runs through the xy plane. In this embodiment example, the component for example has a duromeric foam core 32, for example of duromeric polyurethane foam. In another example, a fibre composite component, in this case a rotor blade 30, can have a component core of another material. In the shown example, the duromeric foam core 32 serves as an object carrier, so that matrix material is deposited additively around the foam core 32. A depositing unit comprises for example a 6-axis geometry, on which for example am extruding mixing head with 6 degrees of freedom can move and deposits a matrix short fibre mixture 33, for example an epoxy resin glass fibre mixture, following the contour of the duromeric foam core 32 and in a layered manner, onto the duromeric foam core 32. In another embodiment, the foam core 32 can also be additively deposited in the same method as the matrix short fibre mixture 33 which encloses the foam core 32. Furthermore, a fibre element 19 is deposited onto the matrix short fibre mixture 33. The fibre element 19, for example of carbon fibre, in particular of HT carbon fibre is designed in each case in an elongate and straight-lined manner. The tensile modulus of elasticity of the HT fibres is about 230 GPa and reinforces the rotor blade 30 with regard to tensile loads in the longitudinal direction of the deposited fibre element 19. In another embodiment example, the fibre elements 10 can also have other shapes.

The present invention also comprises, amongst other things, the following aspects:

1. A method for manufacturing a three-dimensional, multi-layered fibre composite component (11), wherein the method comprises the steps
I. Layered depositing of a curable matrix material (8) onto an object carrier (12) in matrix layers which are arranged above one another, by way of at least one depositing unit (6) which is movable relative to the object carrier (12), wherein the matrix material (8) which has been deposited in a layer forms a matrix layer,
II. At least regional, strand-wise depositing of at least one fibre element (19) onto at least one of the matrix layers by way of at least one laying head which is movable relative to the object carrier (12),
III. Curing the matrix material (8)
   characterised in that the matrix material (8) is a thermosetting polymer and short fibres (20) are embedded into the thermosetting polymer, wherein the short fibres (20) have a smaller length than the deposited fibre element (19).
   2. A method according to aspect 1, characterised in that the matrix material is thixotropic.
   3. A method according to one of the preceding aspects, characterised in that the matrix material (8) is a duromeric foam.
   4. A method according to one of the preceding aspects, characterised in that the matrix material is a fibre-containing matrix or a duromeric foam alternating in layers.
   5. A method according to one of the preceding aspects, characterised in that the matrix layers have a thickness of at least 0.05 mm and at the most 300 mm.
   6. A method according to one of the preceding aspects, characterised in that the object carrier (12) is part of the fibre composite component (11).
   7. A method according to one of the preceding aspects, characterised in that the depositing unit (6) comprises an extruding head.
   8. A method according to one of the preceding aspects, characterised in that the depositing unit (6) and/or the laying head (29) are movable independently of one another.
   9. A method according to one of the preceding aspects, characterised in that the fibre element (19) comprises at least one glass fibre and/or carbon fibre.
   10. A method according to one of the preceding aspects, characterised in that the deposited fibre element (19) has a length of at least 0.5 mm.
   11. A method according to one of the preceding aspects, characterised in that the fibre element (19) is pre-impregnated with a liquid (26) before the deposition onto the matrix material (8).
   12. A method according to one of the preceding aspects, characterised in that the fibre element (19) is embedded at least partly into the matrix material (8).
   13. A method according to one of the preceding aspects, characterised in that the short fibres (20) which are embedded into the matrix material (8) have a length of at least 0.5 mm and at the most 100 mm.
   14. A method according to one of the preceding aspects, characterised in that the short fibres (20) are admixed to the matrix material (8) in the depositing unit (6).
   15. A method according to one of the preceding aspects, characterised in that short fibre(s) (20) is/are embedded into one or more layers of matrix material (8).
   16. A method according to one of the preceding aspects, characterised in that short fibres (20) are deposited between two layers of matrix material (8).
   17. A method according to one of the preceding aspects, characterised in that the short fibres (20) which are embedded into the matrix material (8) are embedded into the matrix material (8) in a directed manner and lie with their longitudinal axis along the traversing path (28) of the depositing unit of the matrix material.
   18. A method according to one of the preceding aspects, characterised in that a volume of the short fibres (20) which are contained in the matrix material (8) is at least 10% with respect to a total matrix volume, wherein the total matrix volume is a sum of the volume of the embedded short fibres (20) and of a volume of the matrix material (8).
   19. A method according to one of the preceding aspects, characterised in that a volume of the short fibres (20) which are contained in the matrix material (8) is different compared to the total matrix volume, in at least two layers, wherein the total matrix volume is a sum of the volume of the embedded short fibres (20) and of a volume of the matrix material (8).
   20. A method according to one of the preceding aspects, characterised in that step II is carried out before step III and/or step III before step II.
   21. A component manufactured by a method according to one of the preceding aspects.

1. A method for manufacturing a three-dimensional, multi-layered fibre composite component, wherein the method comprises
I. Layered depositing of a curable matrix material onto an object carrier in matrix layers that are arranged on top of one another, by way of at least one depositing unit, which is movable relative to the object carrier, wherein the matrix material, which has been deposited in a layer, forms a matrix layer,
II. At least regional, strand-wise depositing of at least one fibre element onto at least one of the matrix layers by way of at least one laying head that is movable relative to the object carrier,
III. Curing the matrix material
wherein the matrix material is a thermosetting polymer and short fibres are embedded into the thermosetting polymer, wherein the short fibres have a smaller length than the deposited fibre element,
and wherein
the fibre-containing matrix material and a duromeric foam are deposited in layers in an alternating manner.

2. The method according to claim 1, wherein the matrix material is thixotropic.

3. The method according to claim 1, wherein the matrix material is a duromeric foam.

4. The method according to claim 1, wherein the matrix layers have a thickness of at least 0.05 mm and at the most 300 mm.

5. The method according to claim 1, wherein the object carrier is part of the fibre composite component.

6. The method according to claim 1, wherein the depositing unit comprises an extruding head.

7. The method according to claim 1, wherein the depositing unit and/or the laying head are movable independently of one another.

8. The method according to claim 1, wherein the deposited fibre element comprises at least one glass fibre and/or carbon fibre.

9. The method according to one of the preceding claims, wherein the deposited fibre element has a length of at least 0.5 mm.

10. The method according to claim 1, wherein the fibre element is pre-impregnated with a liquid before the deposition onto the matrix material.

11. The method according to claim 1, wherein the fibre element is embedded at least partly into the matrix material.

12. The method according to claim 1, wherein the short fibres that are embedded into the matrix material have a length of at least 0.5 mm and at the most 100 mm.

13. The method according to claim 1, wherein the short fibres are admixed to the matrix material in the depositing unit.

14. The method according to claim 1, wherein the short fibre(s) is/are embedded into one or more layers of matrix material.

15. The method according to claim 1, wherein the short fibres are deposited between two layers of matrix material.

16. The method according to claim 1, wherein the short fibres that are embedded into the matrix material are embedded into the matrix material in a directed manner and lie with their longitudinal axis along the traversing path of the depositing unit of the matrix material.

17. The method according to claim 1, wherein a volume of the short fibres that are contained in the matrix material is at least 10% with respect to a total matrix volume, wherein the total matrix volume is a sum of the volume of the embedded short fibres and of a volume of the matrix material.

18. The method according to claim 1, wherein a volume of the short fibres that are contained in the matrix material is different compared to the total matrix volume, in at least two layers, wherein the total matrix volume is a sum of the volume of the embedded short fibres and of a volume of the matrix material.

19. The method according to claim 1, wherein step II is carried out before step III and/or step III before step II.

20. A component manufactured by the method according to claim 1.
